(19) United States
(12) Patent Application Publication
(10) Pub. No.: US 2016/0127617 A1
(43) Pub. Date: May 5, 2016

(54) SYSTEM FOR TRACKING THE POSITION OF THE SHOOTING CAMERA FOR SHOOTING VIDEO FILMS

(71) Applicant: SOLIDANIM, Ivry sur Seine (FR)

(72) Inventors: Isaac PARTOUCHE, Nogent Sur Marne (FR); Jean-François SZLAPKA, Les Lilas (FR); Robert-Emmanuel LINOT, L'lsle d'Espagnac (FR)

(73) Assignee: SOLIDMANIM, Ivry Sur Seine (FR)

(21) Appl. No.: 14/897,806

(22) PCT Filed: Jun. 12, 2014
(86) PCT No.: PCT/FR2014/051423

§ 371 Date: Dec. 11, 2015

(30) Foreign Application Priority Data
Jun. 13, 2013 (FR) 13 55510

(51) Int. Cl. H04N 5/222; H04N 5/225; G06T 17/00

(52) U.S. Cl. CPC H04N 5/2224; G06T 17/00; H04N 5/2254

(57) ABSTRACT

A film shooting system comprises: a camera; a sensor system comprising a first optical sensor system comprising one optical sensor and suitable for recording data in an optical mode, and a second sensor system comprising one sensor, suitable for recording data; a computerised tracking module suitable for incorporating the data from one sensor from the first system and from one sensor from the second system, and for determining location data of the camera from this data; a computerised combination module, suitable for repeatedly determining location data of the camera from both the location data determined in the optical mode and in the second mode.

### FIELD OF THE INVENTION

The present invention relates to systems for tracking the position of a shooting camera for shooting videos.

When shooting video, it may be useful to monitor the position and orientation of the shooting camera in real time.

Indeed, especially for video having augmented reality sequences, the camera movement while shooting must be known to allow reproducing it identically on a virtual camera in a computer program, so that when the actual and virtual scenes are merged they give the impression of having been filmed from the same point of view. This information can also be useful for reconstructing an image if a sequence is missing or did not film well for example.

### BACKGROUND OF THE INVENTION

There are known devices having a spatial tracking system used during shooting via optical sensors. A system marketed under the name of Lightcraft is one example.

In this system, a sensor captures patterns placed on the ceiling with great precision. However, it is desirable to be able to determine the position of the shooting camera with greater flexibility.

### OBJECTS AND SUMMARY OF THE INVENTION

To this end, the invention relates to a system for shooting video in a real space de²fined in a real frame of reference, comprising: a shooting camera, suitable for recording a real image for a plurality of discrete time frames; a sensor system comprising a first optical sensor system comprising at least one optical sensor and suitable for recording data in an optical mode, and a second sensor system comprising at least one sensor, suitable for recording data; a computerized tracking module suitable for incorporating the data from at least one sensor of the first optical sensor system and for determining location data of the shooting camera in the real space based on these data, the computerized tracking module being suitable for incorporating the data from at least one sensor of the second sensor system and for determining location data of the shooting camera in the real space from these data; a computerized combining module, suitable for repeatedly determining location data in the real frame of reference of the shooting camera based on both the location data determined in the optical mode and the location data determined in the second mode.

These features allow pinpointing the location of the shooting camera with greater precision and, above all, alleviating problems of lost information concerning the position of the shooting camera which can occur when using a single system of optical sensors. The combined use of one system of optical sensors and a second system allows improving the overall robustness of the shooting camera tracking system, with data of very different types.

In preferred embodiments of the invention, one or more of the following arrangements may possibly be used:
the computerized combining module determines the position of the shooting camera by combining the positions determined by the first tracking system, determined by the second tracking system, and a weighting coefficient obtained from Ca=aA+(1−a)B, where the weighting coefficient can have the value 0, 1, or between 0 and 1.
the computerized combining module comprises a computer suitable for determining a difference between the location data obtained in the optical mode and in the second mode, thereby generating a result function, and the computerized combining module also comprises a comparator suitable for comparing the function to a threshold value, thereby generating a comparison function, the comparison function taking a value among a list of values; and the computerized combining module also comprises a selector that receives the comparison function as input and outputs the mode selection signal from a list comprising at least the optical mode and the second mode, respectively corresponding to values of the comparison function, the weighting coefficient taking the value 0 or 1 respectively.
the system comprises a button suitable for mechanically selecting a mode from the list.
the first optical sensor system comprises an evaluator suitable for evaluating a number of detectable points of natural topographical information that are detected by the optical sensor, and a reliability module suitable for incorporating the data from the evaluator and outputting a reliability coefficient for the data recorded in optical mode, to enable determining the weighting coefficient for the location data originating from the optical sensor and the sensor.
the selector is suitable for also receiving the reliability coefficient as an input signal.
the second sensor system comprises at least one field-of-view orientation sensor, suitable for determining a mechanical movement resulting in a change of field of view of the shooting camera, and suitable for recording field-of-view change data in a mechanical mode.
the spatial first optical sensor system of the shooting camera comprises at least one optical sensor, providing location data relative to the shooting camera that are known for each time frame, and suitable for transmitting the natural topographical information detected by the optical sensor to the computerized tracking module.
a computerized tracking module compares the natural topographical information detected by the optical sensor, to a predetermined three-dimensional model of the real space.
the tracking system comprises a computerized generation module suitable for generating a predetermined three-dimensional model of the real space, and the optical sensor is suitable for transmitting topographical information detected by said optical sensor to the computerized generation module.
the optical sensor is suitable for transmitting, simultaneously to the computerized tracking module and to the computerized generation module, natural topographical information detected by said optical sensor, and the computerized generation module is suitable for enhancing said predetermined three-dimensional model of the real space according to the natural topographical information detected by the optical sensor.
in the shooting configuration, the shooting camera and optical sensor are fixedly attached to one another.
the field-of-view orientation sensor is an inertial sensor integral to the shooting camera and suitable for recording data concerning changes in position of the shooting camera.
the inertial sensor comprises a gyroscope or an inertia cube.
the shooting camera is carried by a movable support on a base, and the field-of-view orientation sensor comprises a mechanical encoder attached to the support for the shooting camera and suitable for recording data concerning changes in position of the support for the shooting camera.
the system comprises an external mechanical encoder for the internal parameters of the camera, suitable for recording data concerning changes in the internal capture parameters of the camera, such as zoom, diaphragm, focal length.
the data concerning changes in the internal capture parameters of the camera are incorporated into the data input to the computerized tracking module.
the computerized shooting module is suitable for incorporating the data from the signal of the shooting camera and the internal capture parameters of the shooting camera.
the system comprises a device suitable for correcting any distortion of the field of view, this device being suitable for incorporating the camera data and outputting the camera data to the computerized shooting module.

### BRIEF DESCRIPTION OF THE DRAWINGS

Other features and advantages of the invention will be apparent from the following description of one of its embodiments, given by way of non-limiting example with reference to the accompanying drawings.

In the drawings:

FIG. 1 is a view of the real space,

FIG. 2 is a view of the shooting system,

FIG. 3 is a view of the two sensor systems,

FIG. 4 is a flow diagram of the shooting system,

FIG. 5 is a view of the operation of the optical sensor system,

FIG. 6 is a flow diagram of the computerized combining module,

FIG. 7 is a flow diagram of the shooting system.

In the various figures, the same references designate identical or similar elements.

### MORE DETAILED DESCRIPTION

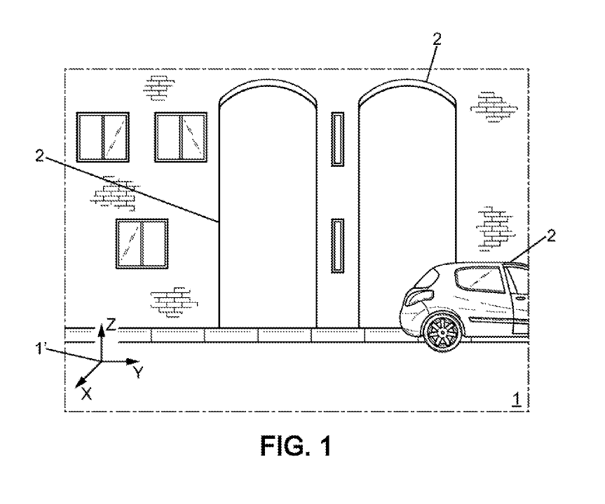

Let us consider a real space 1, with reference to FIG. 1. The real space 1 has natural topographical information 2. This information concerns, for example, geometric objects of the real space 1 such as points, lines, surfaces, and/or volumes. For example, we can consider the edges of a structure as lines, and the intersections of two such edges as points. For surfaces, we can for example consider solid surfaces such as a car hood, etc. For volumes, we can for example refer to objects such as a car or some other object present within the real space 1. The real frame of reference 1′ is a system for identifying locations within the real space 1.

We now describe a system for shooting a video according to one embodiment, in a shooting configuration. A video is a sequence of images (frames) shown in rapid frequency (multiple frames per second, for example 24 (cinema), 25 (PAL), or 30 (NTSC) frames per second) to a spectator. This sequence of images is, for example, projected or distributed as a theater movie, a TV movie, an informational message, a video game, or some other form. In particular, this projection or distribution can take place at a later time than the shooting. The sequence of images recounts an event taking place in a real space 1.

A shooting camera 3 of any type suitable for conventionally filming such a scene is used for this purpose. In particular, a digital camera is used that can capture multiple images per second, for example 24 images (frames) per second.

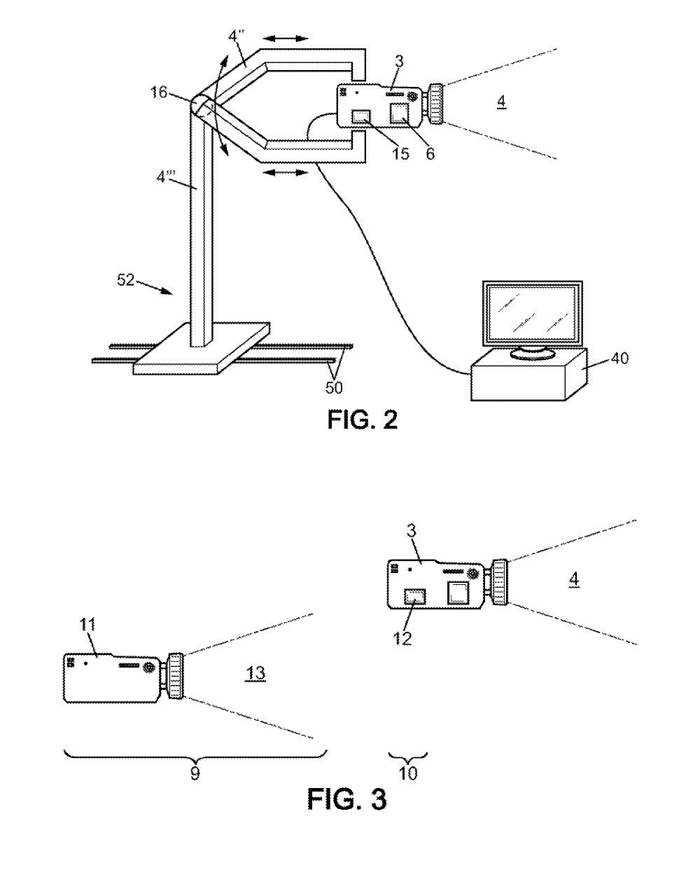

As shown in FIG. 2, the camera 3 includes a lens that can capture images in a field of view 4 and is connected to a computerized shooting module 40. This connection is made for example with a suitable cable, or is wireless, for example via radio transmission or some other means. The shooting camera 3 is of any suitable known type, but the invention is particularly suitable if it is possible to vary the field of view 4 when shooting. In particular, the field of view 4 can be varied by moving the shooting camera 3 within the real space 1.

Such is the case if the shooting camera 3 can be guided to move about within the real space 1, for example by being mounted on a rail 50 or crane 52 having an arm 4″ hinged on a support 4″′ with one, two, or three degrees of freedom, and defining one of the possible locations for the shooting camera 3. Alternatively, a shooting camera 3 is used that is sufficiently compact to be moved about within the real space 1 by an operator who carries it.

According to one embodiment, the shooting camera 3 comprises a monitor mounted on the body of the camera 3 and having a control screen 6 visible to the filming operator displaying the field of view 4 being captured by the camera (shown as closed in FIG. 2).

The shooting system also includes a sensor system 7 for sensing the shooting camera 3 in the real space 1, represented in FIG. 3. The sensor system 7 comprises two sensor systems 9, 10.

The first optical sensor system 9 comprises an optical sensor 11 which is an optical camera, for example as represented in FIG. 3.

The optical sensor 11 has the ability to provide a location relative to the shooting camera 3, that is known at all times. Location is understood here to mean that the position and orientation of the optical sensor 11 relative to the shooting camera 3 are known at all times. In particular, this concerns the relative positions and orientations of the acquisition systems of the optical sensor 11 and of the camera 3 (CCD array for the camera). This can be achieved quite simply by rigidly attaching the optical sensor 11 to the shooting camera 3, for example by means of a clamp or any other suitable mechanical system.

The optical sensor 11 is characterized in particular by a field of capture 13. It is possible, for example, to place the optical sensor 11 so that no part of the shooting camera 3 blocks any of the field of capture 13, and no part of the optical sensor 11 blocks any of the field of view 4.

In one particular embodiment, an optical sensor 11 is used that is specifically dedicated to tracking, and that has acquisition characteristics distinct from the shooting camera 3. Thus, the shooting camera 3 can be dedicated to its task, which is to film, and the optical sensor 11 to its task, which is to locate.

If the optical sensor 11 is attached to the shooting camera, an optical camera of small dimensions may be provided for the optical sensor 11, in particular one that is at least twice as small in volume as the shooting camera 3. The operator thus experiences minimal discomfort.

In particular, an optical camera can be chosen that is specifically dedicated to obtaining the position of the shooting camera within the real space 1 and having a capture rate at least double that of the shooting camera 3, for example about 100 frames per second, thereby smoothing the data by calculating the position of the shooting camera 3 within the real space 1 for each time frame. In particular, one can also select an optical camera having a field of view (solid angle of the field of view) 20 times greater than the field of view 4 of the shooting camera, to maximize the information captured in the real space and usable for calculating the position of the shooting camera. One can therefore use for example a wide angle lens (“fish eye” lens) providing a capture angle exceeding 160 degrees.

The optical sensor 11 is suitable for capturing information relating to the real space 1, to allow determining the position of the optical sensor 11 within the real space 1.

Alternatively to this tracking system, the first optical sensor system 9 may comprise a plurality of optical sensors used successively or simultaneously.

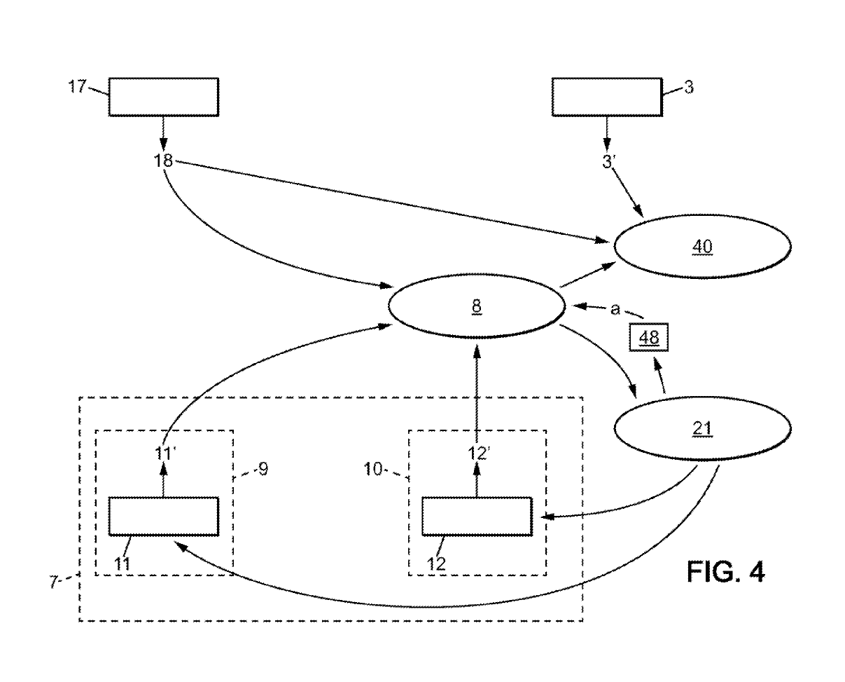

The shooting system also comprises a computerized tracking module 8. The computerized tracking module 8 is suitable for determining location data in the real frame of reference 1′ of the shooting camera 3, based on the location data from the various sensors of the sensor system 7, as shown in FIG. 4.

The computerized tracking module 8 receives the signal originating from a sensor as input, and generates data concerning the position of the shooting camera 3 as output. The computerized tracking module 8 is connected to the sensor by a cable or wirelessly. Alternatively, it may receive data from different sensors at the same time.

In one particular embodiment, the computerized tracking module 8 receives location data 11′ originating from an optical sensor 11 of the first optical sensor system 9.

The computerized tracking module 8 may receive location data originating from multiple optical sensors, successively or simultaneously.

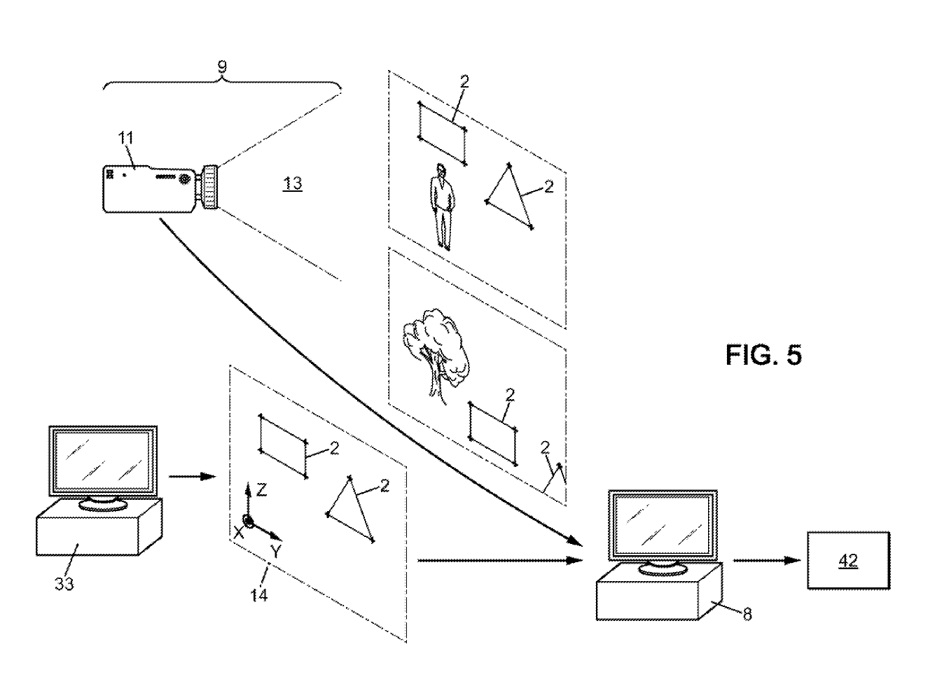

In particular, in the shooting configuration it may be arranged so that location data within the real space 1 is captured by the optical sensor 11, so that the computerized tracking module 8 can determine, for a capture made by the optical sensor 11, using a predetermined three-dimensional model 14 of the real space 1, the position of the optical sensor 11 within the real space 1 (see FIG. 5). Thus, the computerized tracking module 8 will determine the most probable location of the optical sensor 11 within the real space, which makes it possible to match the data captured by the optical sensor 11 with the predetermined three-dimensional model of the real space 1, as shown in FIG. 5.

Knowing the position of the optical sensor 11 within the real space 1, and knowing the relative position of the shooting camera 3 and the optical sensor 11, the computerized tracking module 8 can thus determine the location data of the shooting camera 3 within the real frame of reference 1′.

Alternatively, the position of the shooting camera 3 is directly determined without an explicit determination of the location of the optical sensor 11.

The predetermined three-dimensional model 14 of the real space 1 includes, for example, natural topographic information 2 of the real space 1. This is available for example by any appropriate means.

The three-dimensional model 14 is generated by the computerized generation module 33 during a learning phase, as represented in FIG. 5. This step is, for example, carried out shortly before shooting, so that the real space 1 when shooting corresponds to the predetermined model.

In one particular embodiment, in order to identify the position of the shooting camera 3, the three-dimensional model 14 thus generated is imported into the computerized tracking module 8, and said module compares the natural topographical information 2 detected by the optical sensor 11 with the predetermined three-dimensional model 14 of the real space 1 in order to track at all times, in shooting configuration, the actual position of the shooting camera 3 within the real space 1 as represented in FIG. 5.

Alternatively, the optical sensor 11 transmits topographical information 2 detected by said optical sensor 11 to the computerized generation module 33.

One particular embodiment has just been described for determining the position of the shooting camera 3, using a dedicated optical sensor 11. This sensor may be oriented toward the real space 1 being filmed by the shooting camera 3. One can also use various optical sensors 11 having various orientations. Alternatively, the optical sensor 11 may be the same as the shooting camera 3. In this case, the shooting camera 3 itself is used to determine its own position based on natural topographical data 2.

Alternatively, calibrated markers are used instead of natural topographical data. These markers can be placed outside the field of view 4 of the shooting camera 3, and then a dedicated optical sensor is used to detect them. The computerized tracking module 8 stores in memory the identity and shape of each marker and its position in the real space 1. The computerized tracking module 8 determines the position of the shooting camera 3 based on the captured image of the marker, data in memory, and the respective positions of the optical sensor 11 and shooting camera 3.

The position data determined for the shooting camera 3 may include six variables, and be written for example in the form A=(x, y, z, u, v, w), where x, y, z correspond to the position of a reference point of the shooting camera 3 within the real frame of reference 1′, and u, v, w correspond to the orientation of the shooting camera 3 within this frame of reference 1′.

According to one embodiment, the second sensor system 10 includes a field-of-view orientation sensor 12 as represented in FIG. 3.

This field-of-view orientation sensor 12 allows determining a movement of the shooting camera 3.

The field-of-view orientation sensor 12 can be, for example, an inertial sensor 15 such as an inertia cube or gyroscope. In one particular embodiment, the inertial sensor 15 is attached to the shooting camera 3 as shown in FIG. 2.

Or it may be a mechanical encoder 16 fixed to the support of the shooting camera 3, such as the hinged arm 4″ as shown in FIG. 2. Such an encoder records data concerning changes in position of the support of the shooting camera 3 relative to a base. This mode is therefore also referred to below as “mechanical mode”.

As a variant of this identification system, the second sensor system 10 may comprise a plurality of field-of-view orientation sensors 12 used successively or simultaneously. For example, the shooting camera 3 is carried by a support mounted on a crane 52 having a plurality of hinges and sliding on a rail 50 as shown in FIG. 2. The computerized tracking module 8 can compute the position of the shooting camera using the information provided by the mechanical encoders 16 for each degree of freedom and the system configuration (for example the length of the hinged arm, or the distance between the pivot point of the crane and the reference point of the shooting camera).

In this embodiment, in the case of the second sensor system 10, the data from the field-of-view orientation sensor 12′, concerning a physical movement of the camera 3, are incorporated directly into the data input to the computerized tracking module 8 for locating the position of the shooting camera 3.

As a variant of this second sensor system 10, the computerized tracking module 8 can receive location data from a plurality of field-of-view orientation sensors successively or simultaneously.

The advantage of also working with a mechanical sensor is that in a space without topographical landmarks, such as the desert, the effectiveness of the optical sensor is low.

The position of the shooting camera 3, determined from data detected by the second tracking system, can thus be written for example in the form B=(x2, y2, z2, u2, v2, w2).

In one particular embodiment, this information is sent as input to the computerized tracking module 8 and incorporated into the procedure for identifying the position of the shooting camera 3 as shown in FIG. 4.

These two sensor systems 9, 10 are therefore dedicated for alternate use.

The computerized tracking module 8 may provide several options, to allow determining the position of the shooting camera 3 in real space 1 at any time. For example, in the case where the computerized tracking module 8 is unable to identify topographical information 2 sufficient to determine with certainty the position within real space 1 of the shooting camera 3, by default the shooting camera 3 can be considered to be unmoving at that moment. If the optical sensor 11 is unable to determine topographical information 2, this means that the field of view 4 of the shooting camera 3 is probably blocked by an actual object that is very close. In the next time frame where the optical sensor 11 is able to determine sufficient topographical information 2, the position of the shooting camera 3 in the three-dimensional space can again be determined.

In case of failure, the field-of-view orientation sensor 12 can fill in for the optical sensor 11 and provide information on the position of the shooting camera 3.

The video shooting system comprises a computerized combining module 21 which allows changing from the first optical sensor system 9 to the second sensor system 10 or combining the two tracking systems simultaneously, as represented in FIG. 4.

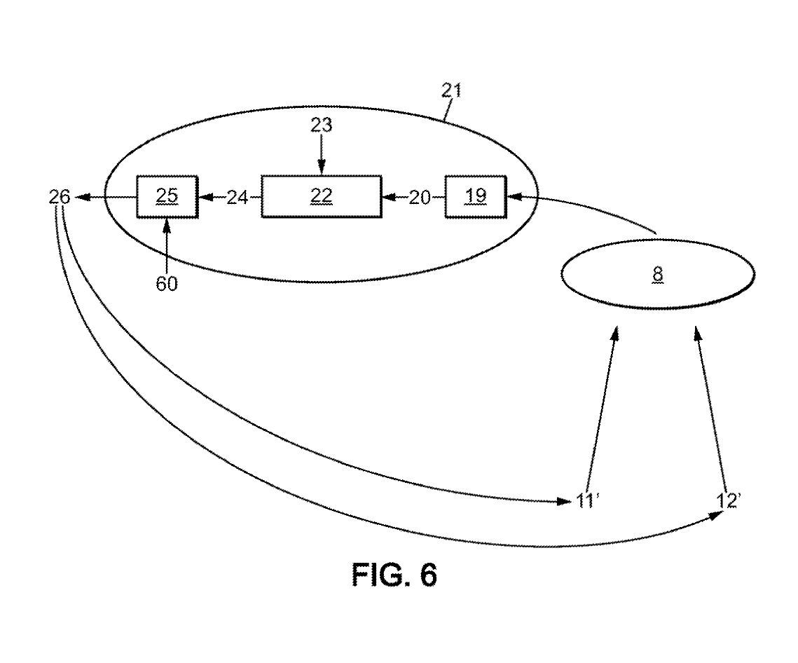

In one embodiment shown in FIG. 6, the location data obtained with the first optical sensor system 9 in optical mode, and the location data obtained with the second sensor system 10 in mechanical mode via the computerized tracking module 8, are integrated in the computerized combining module 21.

The computerized combining module 21 comprises a computer 19. This computer receives the location data obtained in these two modes as input from the computerized tracking module 8, and determines the difference as a result function 20.

This result function 20 is compared to a threshold value 23, via the comparator 22 integrated into the computerized combining module 21. The comparison function 24 which evaluates the difference between the data identified by the optical and mechanical sensors is generated by the comparator 22 and is given a value from a list of two values, each value being assigned to a respective sensor.

The selector 25, also integrated into the computerized combining module 21, takes the comparison function 24 as input and outputs the selection signal 26 for the selected mode among optical mode and mechanical mode. For example, if the location data from the two modes are very close, it may be preferred to use the optical mode if it is known that this gives better accuracy at optimum performance of the two modes. If the location data from the two modes are very different, it may be preferred to choose the mechanical mode if it is known that there is a lower probability of that mode giving a false result.

Alternatively, the user can manually switch from the first optical sensor system 9 to the second sensor system 10, and vice versa.

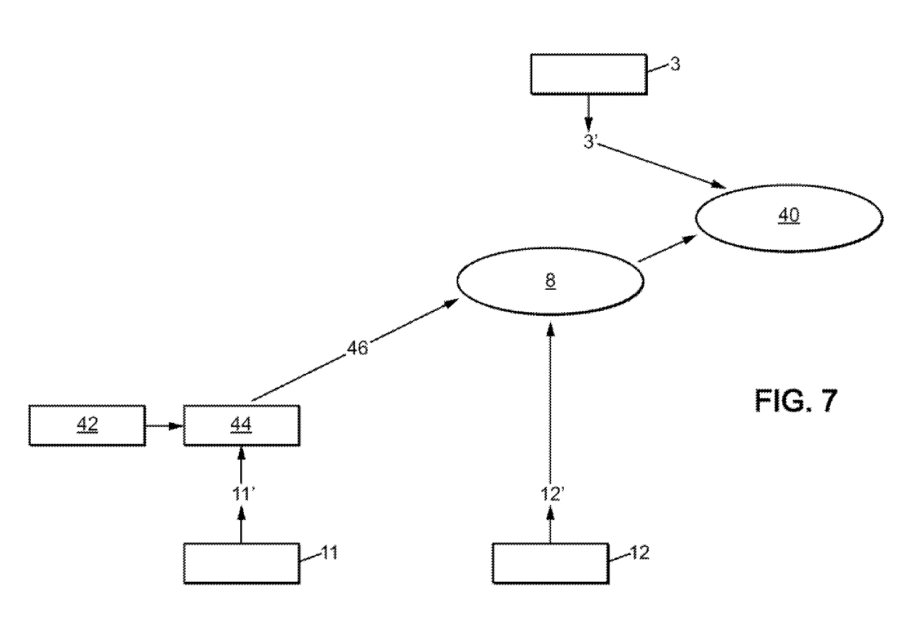

In one particular embodiment represented in FIG. 7, the first system of optical sensors 9 comprises an evaluator 42 (represented in FIG. 5) adapted for evaluating the number of detectable points in the natural topographical information 2 detected, and a reliability module 44 adapted to incorporate the data from the evaluator 42 and to output a reliability coefficient 46 for the data recorded in optical mode.

The computerized combining module 21 is adapted to select a combination of the optical mode and mechanical mode, and comprises a weighting unit 48 as shown in FIG. 4, adapted to weight the location data from the optical sensor 11 and from the field-of-view orientation sensor 12 in the process of determining the location of the shooting camera 3.

Thus, the position data for the shooting camera can be written as C=(x3, y3, z3; u3, v3, w3)=aA+(1−a)B, where “a” is a real weighting coefficient between 0 and 1 inclusive. Note that different weighting coefficients can be used for each field x; y; z; u; v; w. The weighting coefficient “a” can be determined by user selection, or by processing the image obtained by the optical sensor 11, or be based on the difference between the two sets of position data obtained (see examples described above), or by some other method.

The weighting coefficient “a” can be modified over time, as desired, or for each time frame, or for each shoot, for example.

The computerized tracking module 8 which receives and processes the sensor data provides information on the location of the shooting camera 3 to the computerized shooting module 40 as represented in FIG. 7, to allow tracking the position of the shooting camera 3 throughout the take by the shooting camera 3. The computerized tracking module 8 communicates with the computerized shooting module 40 via a cable or wirelessly.

The system may also comprise an external mechanical encoder 17, as shown in FIG. 4, which records data on changes in the internal capture parameters 18 of the camera 3, such as zoom, diaphragm, or focus.

In one particular embodiment, the system comprises a means of taking into account for example a change in lens focal length of the shooting camera 3, by placing an external mechanical encoder 17 on the zoom lens supported by the camera, which allows detecting the degree of rotation of the zoom ring, so that the computerized tracking module 8 takes into account the level of magnification determined from the data transmitted by the external mechanical encoder 17 if the shooting camera 3 is used as an optical sensor 11.

The computerized video shooting module 40 thus receives as input the data recorded by the shooting camera 3 and by the computerized tracking module 8.

The computerized shooting module 40 may also incorporate the internal capture parameters 18.

These internal capture parameters characterize the optical sensor aspect of the shooting camera 3. They are available for a given optical configuration of the shooting camera 3. They are provided, for example, as metadata multiplexed with the video stream from the shooting camera 3.

The shooting system also comprises a device 30 suitable for correcting any distortion of the field of view, this device being suitable for incorporating the camera 3′ data and for outputting the camera 3′ data to the computerized shooting module 40.

Alternatively, the computerized shooting module 40 also comprises a computerized animation module 27. This animation module 27 may, for example, comprise an animation database 28 comprising one or more virtual animations 29. For example, each animation includes, for each time frame in a set of time frames corresponding to all or part of the duration of the video to be filmed, characteristics of three-dimensional objects (point, line, surface, volume, texture, etc.) expressed in a virtual frame of reference. Each animation represents, for example, an augmented virtual reality event. For example, the animation database may provide animations representing a three-dimensional virtual character, possibly movable, a special effect (rain, explosion, etc.), or some other animation.

The computerized shooting module 40 comprises a composition module 30. The composition module 30 imports an animation 29 from the animation module 27 via a link 30.

The computerized composition module then generates, for the time frame in question, a composite image 31 of the actual image captured by the shooting camera 3, and a projection of a virtual image 32 corresponding to the virtual object 31 for the same time frame, the projection being generated based on the location data within the real frame of reference 1′ of the shooting camera 3. Thus, the composite image 31 includes the superimposed actual image and virtual image 32, as if the virtual image 32 was the image of an object in the real space 1, captured by the shooting camera 3 for this time frame. The composite image 31 is then displayed on the control screen. The operator who is filming can thus view, on the control screen 6, the position and orientation of the virtual object in real space 1 for each time frame and for his specific angle of view, as if the virtual object were present in front of him or her. If necessary, the operator can then adjust the position of the shooting camera 3 with respect to the objects.

In another embodiment, missing sequences are reconstructed based on footage filmed just before and after the time of the missing sequence, and on the exact position of the shooting camera 3.

1. System for shooting video in a real space defined in a real frame of reference, comprising:
a shooting camera, suitable for recording a real image for a plurality of discrete time frames,
a sensor system comprising:
a first optical sensor system comprising at least one optical sensor that is distinct from the shooting camera and is adapted for recording data in an optical mode;
a second sensor system comprising at least one sensor, suitable for recording data;
a computerized tracking module suitable for incorporating data from at least one sensor of the first optical sensor system and for determining location data of the shooting camera in the real space based on these data, the computerized tracking module being suitable for incorporating the data from at least one sensor of the second sensor system and for determining location data of the shooting camera in the real space from these data,
a computerized combining module suitable for repeatedly determining location data in the real frame of reference of the shooting camera based on both the location data determined in the optical mode and the location data determined in the second mode.

2. Shooting system according to claim 1, wherein the computerized combining module determines the position of the shooting camera by combining the positions determined by the first tracking system, determined by the second tracking system, and a weighting coefficient obtained from C=aA+(1−a)B, wherein the weighting coefficient can have the value 0, 1, or between 0 and 1.

3. Video shooting system according to claim 2, wherein the computerized combining module comprises a computer suitable for determining a difference between the location data obtained in the optical mode and in the second mode, thereby generating a result function, and wherein the computerized combining module also comprises a comparator suitable for comparing the function to a threshold value, thereby generating a comparison function, the comparison function taking a value among a list of values, and wherein the computerized combining module also comprises a selector that receives the comparison function as input and outputs the mode selection signal from a list comprising at least the optical mode and the second mode, respectively corresponding to values of the comparison function, the weighting coefficient taking the value 0 or 1 respectively.

4. Video shooting system according to claim 1, comprising a button suitable for mechanically selecting a mode from the list.

5. Video shooting system according to claim 2, wherein the first optical sensor system comprises an evaluator suitable for evaluating a number of detectable points of natural topographical information detected by the optical sensor, and a reliability module suitable for incorporating the data from the evaluator and outputting a reliability coefficient for the data recorded in optical mode, to enable determining the weighting coefficient for the location data originating from the optical sensor and the sensor.

6. Video shooting system according to claim 3, wherein the selector is suitable for also receiving the reliability coefficient as an input signal.

7. Video shooting system according to claim 1, wherein the second sensor system comprises at least one field-of-view orientation sensor, suitable for determining a mechanical movement resulting in a change of field of view of the shooting camera, and suitable for recording field-of-view change data in a mechanical mode.

8. Video shooting system according to claim 1, wherein the spatial first optical sensor system of the shooting camera comprises at least one optical sensor, providing location data relative to the shooting camera that are known for each time frame, and suitable for transmitting the natural topographical information detected by the optical sensor to the computerized tracking module.

9. Video shooting system according to claim 7, wherein a computerized tracking module compares the natural topographical information detected by the optical sensor, to a predetermined three-dimensional model of the real space.

10. Video shooting system according to claim 1, wherein the tracking system comprises a computerized generation module suitable for generating a predetermined three-dimensional model of the real space, and wherein the optical sensor is suitable for transmitting topographical information detected by said optical sensor to the computerized generation module.

11. Video shooting system according to claim 10, wherein the optical sensor is suitable for transmitting simultaneously to the computerized tracking module and to the computerized generation module, natural topographical information detected by said optical sensor, and wherein the computerized generation module is suitable for enhancing said predetermined three-dimensional model of the real space according to the natural topographical information detected by the optical sensor.

12. Video shooting system according to claim 1, wherein, in the shooting configuration, the shooting camera and the optical sensor are fixedly attached to one another.

13. Video shooting system according to claim 1, wherein the field-of-view orientation sensor is an inertial sensor integral to the shooting camera and suitable for recording data concerning changes in position of the shooting camera.

14. Video shooting system according to claim 13, wherein the inertial sensor comprises a gyroscope or an inertia cube.

15. Video shooting system according to claim 1, wherein the shooting camera is carried by a movable support on a base, and the field-of-view orientation sensor comprises a mechanical encoder attached to the support for the shooting camera and suitable for recording record data concerning changes in position of the support for the shooting camera.

16. Video shooting system according to claim 1, comprising an external mechanical encoder for the internal parameters of the camera suitable for recording data concerning changes in the internal capture parameters of the camera, such as zoom, diaphragm, focal length.

17. Video shooting system according to claim 16, wherein the data concerning changes in the internal capture parameters of the camera are incorporated into the data input to the computerized tracking module.

18. Video shooting system according to claim 1, wherein the computerized shooting module is suitable for integrating the data from the signal of the shooting camera and the internal capture parameters of the shooting camera.

19. Video shooting system according to claim 1, comprising a device suitable for correcting any distortion of the field of view, this device being suitable for incorporating the camera data and outputting the camera data the computerized shooting module.

20. Video shooting system according to claim 3, wherein the first optical sensor system comprises an evaluator suitable for evaluating a number of detectable points of natural topographical information detected by the optical sensor, and a reliability module suitable for incorporating the data from the evaluator and outputting a reliability coefficient for the data recorded in optical mode, to enable determining the weighting coefficient for the location data originating from the optical sensor and the sensor.
